(19) United States
(12) Patent Application Publication
(10) Pub. No.: US 2007/0147182 A1
(43) Pub. Date: Jun. 28, 2007

(54) Child's training clock and organizer

(76) Inventors: Michael Allister Witchey, Solana Beach, CA (US); Deborah Beth Witchey, Solana Beach, CA (US)

Correspondence Address: Michael A. Witchey, 417 Santa Victoria, Solana Beach, CA, 92075, US

(21) Appl. No.: 11/318,280

(22) Filed: Dec. 27, 2005

(51) Int. Cl. G04B 19/00

(52) U.S. Cl. 368/223

(57) ABSTRACT

The Child's Training Clock and Organizer is an apparatus designed to help teach children the concepts of telling and measuring time, scheduling, and time management. This is done with a dual 12 hour clock set up and event markers that can be placed on the clock faces and/or a hanging optional calendar to mark daily tasks to be done or special events. An independent timer with an audible alarm helps the child get a feel for fixed time spans. We have not seen or are unaware of anything like this in the market today or in the past.

### BACKGROUND OF THE INVENTION

The idea for the Child's Training Clock and Organizer came about from an argument between the inventor and his 3-year-old son as to when playtime was to end and book reading time was to begin prior to his bedtime. The inventor felt a need to teach his son the concept of time and time management. The parent can use the clock and calendar as a backup to his/her authority to get a child to perform tasks in a timely manner with little argument with the child.

### BRIEF SUMMARY OF THE INVENTION

The Child's Training Clock and Organizer consists of a dual 12 hour clock apparatus with an optional hanging calendar designed to help children not only learn to measure time but learn how time is allotted for given daily tasks and scheduling. The calendar option can help a child anticipate events such as birthdays and holidays. The invention has movable markers that parents can place on the clock faces to represent the time allotted for performing specified tasks. These markers can be used with the calendar as well. There is also a built in timer that can be used for example to give a child a specific amount of time to play before an alarm sounds to signal that play time is over.

### DESCRIPTION OF DRAWINGS

FIG. 1 is a plan view of the Child's Training Clock and Organizer. Item 1 is the dual 12-hour clock unit. This unit comprises of a daytime clock represented by a sun (item 2), and a nighttime clock represented by a moon (item 3). A marker is shown in use as an example by Item 4 on the daytime clock and on the calendar. Item 5 is a battery operated timer. Item 6 is the calendar which can be a magnetic dry erase type whiteboard. Item 7 shows a typical day cell of the calendar. Item 8 represents an area where spare markers can be stored or a place to leave notes.

FIG. 2 is a perspective view of the Child's Training Clock and Organizer showing both the clock unit and calendar.

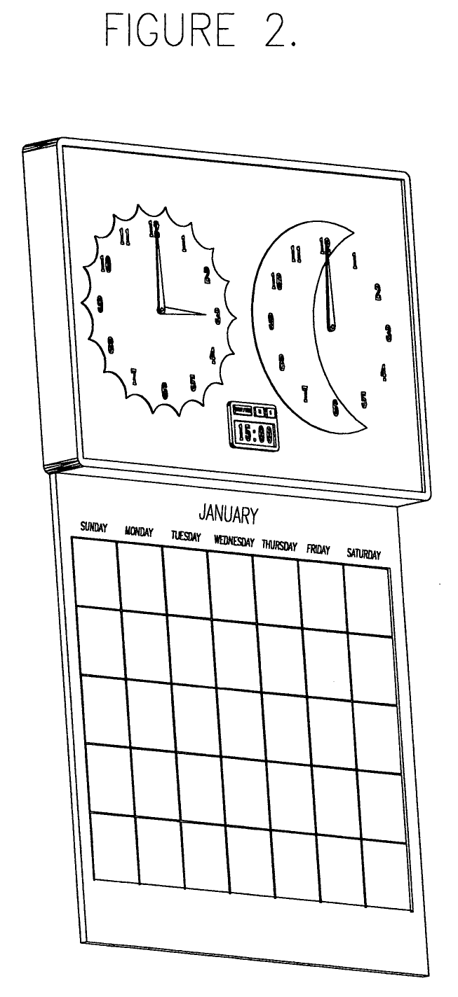

### DETAILED DESCRIPTION OF THE INVENTION

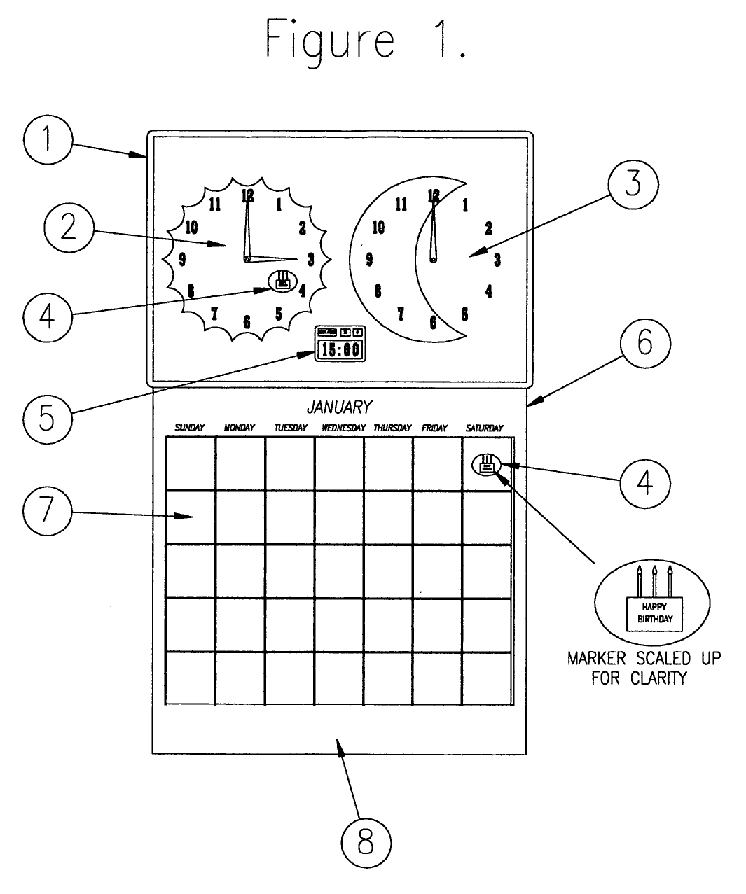

The Child's Training Clock and Organizer is a dual clock unit with an optional hanging or attached calendar designed to help children learn to manage their time. The dual clock unit (item 1, FIG. 1) has a daytime clock, (item 2, FIG. 1) with a sun as its face; a nighttime clock with a moon as its face (item 3, FIG. 1); and a battery operated timer (item 5, FIG. 1). Each clock can be activated or shut off by use of custom set timers built into the back of the unit.

For example, the daytime clock can activate at the child's wake up time, (7:00 AM), as well as illuminate while the nighttime clock deactivates. The daytime clock is operational up to say 6:00 PM. At this time the daytime clock deactivates while the night time clock activates and illuminates.

The clocks have features unique for distinction between night and day. The daytime clock uses a sun as its face and daytime animals on the hour and minute hands. The nighttime clock uses nocturnal animals to represent the hour and minute hands. In addition, quick animals represent the minute hands and slow animals represent the hour hands. The second hands of both clocks may or may not be represented by animals.

The fascia of the clock unit can support magnets as well as be drawn on with dry erase pens. This allows parents the option to place magnetic markers (item 4, FIG. 1) on either clock face or draw on either face.

A battery-operated timer with an audible alarm (item 5, FIG. 1) is installed on the clock unit to be used for timed events such as playtime before dinner.

The hanging calendar (item 6, FIG. 1) is a magnetic dry-erase type sheet that has cells (item 7, FIG. 1) that represent the days of the calendar. These cells can be flush or recessed into the calendar surface. The area at the bottom of the calendar (item 8, FIG. 1) can be used to write notes with a dry-erase pen or a place to store additional magnetic markers. The dimensions of the Child's Training Clock and Organizer can be varied to fit specific needs and design requirements.

1. We claim that the Child's Training Clock and Organizer is a dual clock apparatus with an optional hanging calendar used with markers designed to help a child learn his/her daily routine as well as get a feel for the concept of time and time management.

2. We claim that the Child's Training Clock and Organizer is a dual clock apparatus as claimed in claim 1 that incorporates an adjustable mechanism which would allow only one of the two clocks to operate within a 12 hour time cycle.
For example: The adjustable mechanism can be set to allow the daytime clock to activate at the child's wake up time and deactivate the nighttime clock at the same time. This mechanism may also incorporate an audible alarm as an option.

3. We claim that the Child's Training Clock and Organizer incorporates an adjustable mechanism as claimed in claim 2 that also has the option of illuminating the active clock and darkening the inactive clock.

4. We claim that the Child's Training Clock and Organizer is a dual clock apparatus as claimed in claim 1 that uses movable markers that can be placed on the clock faces or optional calendar to signify the beginning or ending of a task or mark a significant event. These markers can be made of materials such as sheet magnets, reusable stickers, hook and loop, or other materials that would allow extended use.

5. We claim that the artwork on the markers of claim 4 describe events typical to a child's day and night. Such events may include the following:
Wake up Breakfast Leave for School Lunch Nap Dinner Bath Book time Play time Brush Teeth Bed time Birthdays Holidays Doctor appointment Bottle time Medicine time

6. We claim that the Child's Training Clock and Organizer is a dual clock apparatus as claimed in claim 1 that incorporates an independent minute/second timer with an audible alarm that can be used by a parent for allotting time in short spans.
For example: The parent can allot an extra 15 minutes of playtime to a child as a reward for good behavior. The alarm lets the child and parent know that time is up.

7. We claim that that the Child's Training Clock and Organizer is a dual clock apparatus as claimed in claim 1 that uses daytime animals to appear as art on the minute and hour hands of the daytime clock. The night time clock uses nocturnal animals as art on the minute and hour hands. Fast animals are on the minute hands and slow animals are on the hour hands of both clocks.

8. We claim that that the Child's Training Clock and Organizer is a dual clock apparatus as claimed in claim 1 that uses a figure of a sun to appear as art on the daytime clock and uses a figure of a moon to appear as art on the night time clock.
